(19) United States
(12) Patent Application Publication
(10) Pub. No.: US 2017/0184068 A1
(43) Pub. Date: Jun. 29, 2017

(54) HYDROELECTRIC POWER GENERATOR

(71) Applicant: Xiamen Runner Industrial Corporation, Xiamen (CN)

(72) Inventors: ZHAO-YI ZHUO, Xiamen (CN); SHENG-JUN DU, Xiamen (CN); SHENG-CHAO DAI, Xiamen (CN); WEN-HUA YE, Xiamen (CN)

(21) Appl. No.: 15/367,619

(22) Filed: Dec. 2, 2016

(30) Foreign Application Priority Data
Dec. 25, 2015 (CN) 201521092426.0

(51) Int. Cl. F03B 1/00; H02K 7/18; F03B 13/00; F03B 11/06; F03B 11/00

(52) U.S. Cl. CPC F03B 1/00; F03B 11/06; F03B 11/006; F03B 13/00; H02K 7/1823

(57) ABSTRACT

A hydroelectric power generator, comprising: a plastic seal outer shell;

a skeleton main body, disposed in the plastic seal shell; an embossed flat axis, disposed penetrating in the skeleton main body; an impeller, connected and fixed to one end of the embossed flat axis, to drive the embossed flat axis into rotation;
a magnet, sleeved around the embossed flat axis; a copper coil, disposed around the skeleton main body; a driving plate, connected and fixed to one end of the plastic seal shell, to drive the impeller into rotation; and a plurality of water input bosses, extending slantwise on the driving plate, having water input holes provided thereon. The hydroelectric power generator is simple in structure, easy to manufacture. In which, the slant water input holes on the driving plate are used in cooperation with the impeller, to raise the impact of the water flow.

### BACKGROUND OF THE INVENTION

Field of the Invention

The present invention relates to bathing, sanitary, and related equipment, and in particular to a hydroelectric power generator used in providing power to the bathing and sanitary equipment.

The Prior Arts

In general, hydroelectric power generator is used to convert water energy into electric energy. However, presently, the power conversion efficiency of the hydroelectric power generator is not good enough, such that the water energy can not be used efficiently, while voltage of the output power is not sufficient to meet the requirement of the bathing, sanitary equipment.

Therefore, presently, the design and performance of the hydroelectric power generator is not quite satisfactory, and it leaves much room for improvement.

### SUMMARY OF THE INVENTION

In view of the problems and drawbacks of the prior art, the present invention provides a hydroelectric power generator, that is novel in design, stable in operation, to raise output power voltage under the condition of low water flow pressure.

In a first embodiment of the present invention, the present invention provides a hydroelectric power generator, comprising: a hydroelectric power generator, comprising: a plastic seal outer shell; a skeleton main body, disposed in the plastic seal shell; an embossed flat axis, disposed penetrating in the skeleton main body; an impeller, connected and fixed to one end of the embossed flat axis, to drive the embossed flat axis into rotation; a magnet, sleeved around the embossed flat axis; a copper coil, disposed around the skeleton main body; a driving plate, connected and fixed to one end of the plastic seal shell, to drive the impeller into rotation; and a plurality of water input bosses, extending slantwise on the driving plate, having water input holes provided thereon.

In an aspect of the first embodiment of the present invention, the hydroelectric power generator further includes: a skeleton rear cover, connected and fixed to one end of the skeleton main body, and on the skeleton rear cover is provided with an axis hole, used to install the embossed flat axis; and a graphite pad, disposed in the axis hole. Wherein, one end of the embossed flat axis is connected into the skeleton rear cover through a bearing, while the other end of the embossed flat axis is connected into the skeleton main body through other bearing.

In another aspect of the first embodiment of the present invention, the hydroelectric power generator further includes: an axial sleeve, disposed in the skeleton main body, and located between the magnet and the embossed flat axis, and sleeved around the embossed flat axis; and a shell, sleeved around the magnet, to separate the magnet and water.

In a further aspect of the first embodiment of the present invention, the hydroelectric power generator further includes: a rear cover, connected and fixed to the other end of the plastic seal outer shell; and a conductive wire, disposed on the rear cover.

In a second embodiment of the present invention, the hydroelectric power generator includes: a plastic seal outer shell; a skeleton main body, disposed in the plastic seal shell; an embossed flat axis, disposed penetrating in the skeleton main body; an impeller, connected and fixed to one end of the embossed flat axis, to drive the embossed flat axis into rotation; a magnet, sleeved around the embossed flat axis; a copper coil, disposed around the skeleton main body; and a magnetic protection ring, disposed on the skeleton main body, to raise voltage of output power.

In an aspect of the second embodiment of the present invention, the hydroelectric power generator further includes: a skeleton rear cover, connected and fixed to one end of the skeleton main body, and on the skeleton rear cover is provided with an axis hole, used to install the embossed flat axis; and a graphite pad, disposed in the axis hole. Wherein, one end of the embossed flat axis is connected into the skeleton rear cover through a bearing, while the other end of the embossed flat axis is connected into the skeleton main body through other bearing.

In another aspect of the second embodiment of the present invention, the hydroelectric power generator further includes: an axial sleeve, disposed in the skeleton main body, and located between the magnet and the embossed flat axis, and sleeved around the embossed flat axis; and a shell, sleeved around the magnet, to separate the magnet and water.

In a further aspect of the second embodiment of the present invention, the hydroelectric power generator further includes: a rear cover, connected and fixed to the other end of the plastic seal outer shell; and a conductive wire, disposed on the rear cover.

Compared with the existing technology, the present invention has the advantages that, the hydroelectric power generator is simple in structure, easy to manufacture. In which, the slant water input holes on the driving plate are used in cooperation with the impeller, to raise the impact of the water flow. Further, a magnetic protection ring is provided, to increase effectively the output power voltage of the generator, such that the output power voltage of the generator can meet the requirement of the load, even when the water flow pressure is low.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detail descriptions.

### BRIEF DESCRIPTION OF THE DRAWINGS

The related drawings in connection with the detailed descriptions of the present invention to be made later are described briefly as follows, in which:

FIG. 1 is an exploded view of a hydroelectric power generator according to a first embodiment of the present invention;

FIG. 2 is a schematic diagram of a driving plate according to the present invention; and

FIG. 3 is an exploded view of a hydroelectric power generator according to a second embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

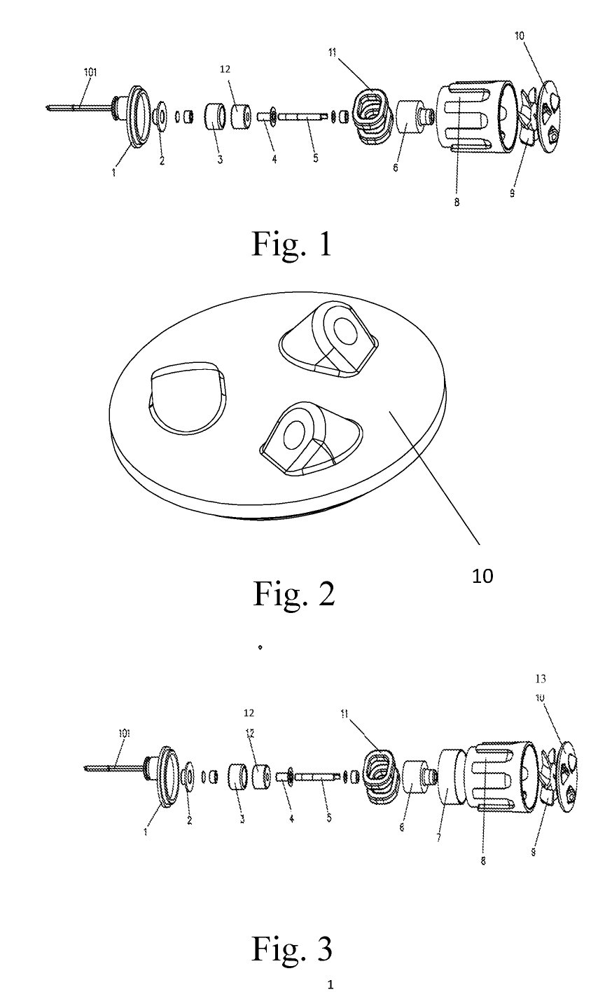

Refer to FIGS. 1 to 3 respectively for is an exploded view of a hydroelectric power generator according to a first embodiment of the present invention;

a schematic diagram of a driving plate according to the present invention; and
an exploded view of a hydroelectric power generator according to a second embodiment of the present invention.

As shown in FIGS. 1 and 2, the first embodiment of the present invention provides a hydroelectric power generator, that includes: a plastic seal outer shell 8; a skeleton main body 6, disposed in the plastic seal shell 8; an embossed flat axis 5, disposed penetrating in the skeleton main body 6; an impeller 9, connected and fixed to one end of the embossed flat axis 5, to drive the embossed flat axis 5 into rotation; a magnet 12, sleeved around the embossed flat axis 5; a copper coil 11, disposed around the skeleton main body 6; a driving plate 10, connected and fixed to one end of the plastic seal shell 8, to drive the impeller 9 into rotation; and a plurality of water input bosses, extending slantwise on the driving plate 10, having water input holes provided thereon.

In the first embodiment of the present invention, the hydroelectric power generator further includes: a skeleton rear cover 2, connected and fixed to one end of the skeleton main body 6, and on the skeleton rear cover 2 is provided with an axis hole, used to install the embossed flat axis 5; and a graphite pad, disposed in the axis hole. Wherein, one end of the embossed flat axis 5 is connected into the skeleton rear cover 2 through a bearing, while the other end of the embossed flat axis 5 is connected into the skeleton main body 6 through other bearing.

In the first embodiment of the present invention, the hydroelectric power generator further includes: an axial sleeve 4, disposed in the skeleton main body 6, and located between the magnet 12 and the embossed flat axis 5, and sleeved around the embossed flat axis 5; and a shell 3, sleeved around the magnet 12, to separate the magnet 12 and water.

In the first embodiment of the present invention, the hydroelectric power generator further includes: a rear cover 1, connected and fixed to the other end of the plastic seal outer shell 8; and a conductive wire 101, disposed on the rear cover 1.

As shown in FIG. 3, the second embodiment of the present invention provides a hydroelectric power generator, that includes: a plastic seal outer shell 8; a skeleton main body 6, disposed in the plastic seal shell 8; an embossed flat axis 5, disposed penetrating in the skeleton main body 6; an impeller 9, connected and fixed to one end of the embossed flat axis 5, to drive the embossed flat axis 5 into rotation; a magnet 12, sleeved around the embossed flat axis 5; a copper coil 11, disposed around the skeleton main body 6; and a magnetic protection ring 7, disposed on the skeleton main body 6, to raise voltage of output power.

In the second embodiment of the present invention, the hydroelectric power generator further includes: a skeleton rear cover 2, connected and fixed to one end of the skeleton main body 6, and on the skeleton rear cover 2 is provided with an axis hole, used to install the embossed flat axis 5; and a graphite pad, disposed in the axis hole. Wherein, one end of the embossed flat axis 5 is connected into the skeleton rear cover 2 through a bearing, while the other end of the embossed flat axis 5 is connected into the skeleton main body 6 through other bearing.

In the second embodiment of the present invention, the hydroelectric power generator further includes: an axial sleeve 4, disposed in the skeleton main body 6, and located between the magnet 12 and the embossed flat axis 5, and sleeved around the embossed flat axis 5; and a shell 3, sleeved around the magnet 12, to separate the magnet 12 and water.

In the second embodiment of the present invention, the hydroelectric power generator further includes: a rear cover 1, connected and fixed to the other end of the plastic seal outer shell 8; and a conductive wire 101, disposed on the rear cover 1.

In the second embodiment of the present invention, magnetic protection ring 7 is made of galvanized plate, to raise the generator output power voltage under the same generator rotation speed. Cylinder-shape turret-type water slant holes are utilized, to ensure water output angle to be more accurate, so that water flow can be more concentrated to impact on the impeller 9. As such, even under low water flow pressure, the rotation speed of the generator can be increased, to raise the output power voltage of the generator. Further, secondary injection is utilized such that the magnet 12 is completely insulated from water through encapsulation, to prevent corrosion of the magnet 12, thus avoiding the generator magnet water corrosion problem caused by surface barrel plating treatment of the magnet 12. 3-dimensional (3D) turbine blade design is used, so the impeller 9 rotation speed can be raised, under the same water flow impact, hereby raising the output power voltage of a generator. The water slant holes are designed into turret type, to work in cooperation with the 3D turbine blade, so that the impeller 9 may obtain higher rotation speed, under lower water flow pressure. In addition, the magnetic protection ring 7 is able to protect the strength of the magnetic field, such that the generator can provide higher output power voltage even having the same rotation speed. In this approach, the problem that under low water flow pressure, generator output voltage can not meet the requirement of load, can be solved.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A hydroelectric power generator, comprising:
a plastic seal outer shell;
a skeleton main body, disposed in the plastic seal shell;
an embossed flat axis, disposed penetrating in the skeleton main body;
an impeller, connected and fixed to one end of the embossed flat axis, to drive the embossed flat axis into rotation;
a magnet, sleeved around the embossed flat axis;
a copper coil, disposed around the skeleton main body;
a driving plate, connected and fixed to one end of the plastic seal shell, to drive the impeller into rotation; and
a plurality of water input bosses, extending slantwise on the driving plate, having water input holes provided thereon.

2. The hydroelectric power generator as claimed in claim 1, further comprising:
a skeleton rear cover, connected and fixed to one end of the skeleton main body, and on the skeleton rear cover is provided with an axis hole, used to install the embossed flat axis; and
a graphite pad, disposed in the axis hole;
wherein, one end of the embossed flat axis is connected into the skeleton rear cover through a bearing, while another end of the embossed flat axis is connected into the skeleton main body through another bearing.

3. The hydroelectric power generator as claimed in claim 1, further comprising:
an axial sleeve, disposed in the skeleton main body, and located between the magnet and the embossed flat axis, and sleeved around the embossed flat axis; and
a shell, sleeved around the magnet, to separate the magnet and water.

4. The hydroelectric power generator as claimed in claim 1, further comprising:
a rear cover, connected and fixed to another end of the plastic seal outer shell; and
a conductive wire, disposed on the rear cover.

5. A hydroelectric power generator, comprising:
a plastic seal outer shell;
a skeleton main body, disposed in the plastic seal shell;
an embossed flat axis, disposed penetrating in the skeleton main body;
an impeller, connected and fixed to one end of the embossed flat axis, to drive the embossed flat axis into rotation;
a magnet, sleeved around the embossed flat axis;
a copper coil, disposed around the skeleton main body; and
a magnetic protection ring, disposed on the skeleton main body, to raise voltage of output power.

6. The hydroelectric power generator as claimed in claim 5, further comprising:
a skeleton rear cover, connected and fixed to one end of the skeleton main body, and on the skeleton rear cover is provided with an axis hole, used to install the embossed flat axis; and
a graphite pad, disposed in the axis hole;
wherein, one end of the embossed flat axis is connected into the skeleton rear cover through a bearing, while another end of the embossed flat axis is connected into the skeleton main body through other bearing.

7. The hydroelectric power generator as claimed in claim 5, further comprising:
an axial sleeve, disposed in the skeleton main body, and located between the magnet and the embossed flat axis, and sleeved around the embossed flat axis; and
a shell, sleeved around the magnet, to separate the magnet and water.

8. The hydroelectric power generator as claimed in claim 5, further comprising:
a rear cover, connected and fixed to another end of the plastic seal outer shell; and
a conductive wire, disposed on the rear cover.
